(19) United States
(12) Patent Application Publication
(10) Pub. No.: US 2026/0148218 A1
(43) Pub. Date: May 28, 2026

(54) INTELLIGENT AUTODRAFT

(71) Applicant: Bank of America Corporation, Charlotte, NC (US)

(72) Inventors: Hannah Furr, Charlotte, NC (US); Amy M. McNeil, Charlotte, NC (US); Quentin Petty, Charlotte, NC (US); Reginald R. Hayes, Charlotte, NC (US); Richard E. Dillahunt, Charlotte, NC (US)

(21) Appl. No.: 18/958,241

(22) Filed: Nov. 25, 2024

(51) Int. Cl. G06Q 20/22

(52) U.S. Cl. CPC G06Q 20/227

(57) ABSTRACT

Systems and methods for automatically directing actions of an entity for transactions. The method may include receiving, at a GPU, a request to complete a transaction. The GPU may run an AI model to automatically direct actions of the entity by gathering entity-focused factors and regional factors for use in determining which accounts to use to complete the transaction that minimize resource consumption and maximize fluidity of the accounts. Entity-focused factors may include accounts available, account balances, timing of the transaction, currency of each account, currency requirements for the transaction, predetermined fluidity thresholds, and/or resource consumption of the transaction. Regional factors may relate to purchasing power parity between currency choices, relative economic strength of the regions issuing the currency choices, and/or economic modeling of the regions. Using the factors obtained, the GPU may run the AI model to determine and automatically direct actions of the entity to complete the transaction.

### FIELD OF TECHNOLOGY

Aspects of the disclosure relate to using an artificial intelligence (“AI”) model to automatically direct actions of an entity to complete transactions while using resources efficiently.

### BACKGROUND

Inefficient use of resources available to an entity, such as an organization or a corporation, may lead to wastefulness, loss of resources, and/or expenditures. Resources may include machinery, technology such as computing technology and network bandwidth, buildings, vehicles, tools, and/or mediums of exchange. Entities may need more efficient ways to oversee their usage of resources under their supervision.

### SUMMARY

Provided herein are systems and methods for efficient supervision of entity consumption of resources. Also provided herein are systems and methods for automatically directing actions of an entity to complete transactions using entity-focused factors and regional factors. Systems and methods are also provided for automatically directing actions of an entity.

The methods may include automatically directing actions of an entity using entity-focused factors and regional factors. The methods may include a graphics processing unit (“GPU”) of the entity receiving a request to complete a transaction. The GPU may run an AI model. When running on the GPU, the AI model may automatically direct actions of the entity. The AI model may automatically direct actions of the entity by gathering entity-focused factors and regional factors used to determine which account to use to complete the transaction. The AI model may automatically direct actions of the entity to use an account that minimizes resource consumption.

Minimizing resource consumption may include minimizing the use of hardware computing resources. Minimizing resource consumption may include minimizing the use of bandwidth. Bandwidth may include bandwidth of a communication network. Resource consumption may include minimizing the amount of physical location needed. Resource consumption may include capital resource consumption. Capital resources may include machinery and technology such as computing technology, buildings, vehicles, and/or tools. Resource consumption may include the use of a medium of exchange such as currency.

The GPU may determine automatically a first series of factors with which to provide the AI model. The first series of factors may include entity-focused factors. The entity-focused factors may include accounts available to the entity for completing the transaction. The entity-focused factors may include a time limit for completing the transaction. The entity-focused factors may include accounts available to the entity for completing the transaction. The entity-focused factors may include the currency of the account balance for each account. The entity-focused factors may include the currency choices available for completing the transaction. The entity-focused factors may include the resource consumption associated with an account when used to complete the transaction.

The GPU may determine automatically a second series of factors with which to provide the AI model. The second series of factors may include regional factors. One or more of the second series of factors may be used by the AI model. The second series of factors may relate to predicting values of the currency choices available.

The regional factors may include purchasing power parity between the currency choices available for completing the transaction. The regional factors may include the relative economic strength of regions issuing the currency choices available for completing the transaction. The regional factors may include economic modeling for the regions in which the currency choices are available for completing the transaction.

The GPU may provide automatically the first series of factors and the second series of factors to the AI model. The GPU may run the AI model to direct automatically the actions of the entity to complete the transaction in a way that minimizes resource consumption incurred by the entity to complete the transaction, where the AI model uses the first series of factors and the second series of factors.

The entity-focused factors may further include determining automatically a low balance fee for each account when the account balance falls below a predetermined low balance threshold. The entity-focused factors may further include determining automatically a cost of an overdraft fee for each account when the account is overdrawn. The entity-focused factors may further include determining automatically an interest rate provided for the account balance in each account.

The method may further include using the AI model to automatically direct the actions of the entity by gathering entity-focused factors and regional factors used to determine which account to use to complete the transaction in a way that minimizes resource consumption and maximizes fluidity for each account. Maximizing the fluidity of an account may include maintaining the account balance to be greater than a predetermined fluidity threshold. The GPU may run the AI model to maximize the fluidity of each account by maintaining the account balance of each account to be greater than a predetermined fluidity threshold.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram configured to provide automated direction of actions of an entity using entity-focused factors and regional factors to minimize resource consumption in accordance with the principles of the disclosure;

FIG. 2 shows an illustrative flowchart for providing automated direction of actions of an entity using entity-focused factors and regional factors to minimize resource consumption in accordance with the principles of the disclosure;

FIG. 3 shows an illustrative flowchart for providing automated direction of actions of an entity using entity-focused factors and regional factors to minimize resource consumption and maximize fluidity in accordance with the principles of the disclosure;

FIG. 4 shows an illustrative block diagram in accordance with principles of the disclosure; and

FIG. 5 shows an illustrative block diagram in accordance with principles of the disclosure.

### DETAILED DESCRIPTION

Systems and methods may provide for automated direction of actions of an entity using entity-focused factors and regional factors. Systems and methods may also provide for automated direction of actions of the entity.

The systems for automated direction of actions of an entity using entity-focused factors and regional factors may include a digital platform of an organization. The digital platform may include a GPU of the entity and an AI model.

The systems may provide for automatically directing actions of an entity using entity-focused factors and regional factors. The systems may include the GPU. The GPU may be configured to receive a request to complete a transaction. The GPU may be configured to run the AI model. When running on the GPU, the AI model may be used to automatically direct actions of the entity. The AI model may automatically direct actions of the entity by gathering entity-focused factors and regional factors used to determine which one or more accounts to use to complete the transaction. The AI model may automatically direct action of the entity to use one or more accounts that minimize resource consumption.

The GPU may run the AI model by using parallel processing to break down computations into smaller chunks and distribute them across thousands of cores. The GPU may be well suited to perform parallel processing. Parallel processing may be necessary for the complex mathematical computations and matrix multiplication that are common in AI algorithms. An AI algorithm may run the AI model.

Minimizing resource consumption may include minimizing the use of hardware computing resources. It may be preferable to complete the transaction in a way that uses less hardware computing resources. For example, less hardware computing resources may be required for completing the transaction using one account over another account. For example, the hardware computing resource may be used for less time when using one account over another account.

Minimizing resource consumption may include minimizing the use of software computing resources. It may be preferable to complete the transaction in a way that uses less software computing resources. For example, less software computing resources may be required for completing the transaction using one account over another account. For example, the software computing resource may be used for less time when using one account over another account.

Minimizing resource consumption may include minimizing the use of bandwidth. Bandwidth may include network bandwidth. It may be preferable to complete the transaction in a way that uses less bandwidth. For example, less bandwidth may be required for completing the transaction using one account over another account due to less information that needs to be conveyed over the bandwidth. For example, less bandwidth may be required for completing the transaction using one account over another account due to less time that the information needs to be conveyed over the bandwidth.

Minimizing resource consumption may include minimizing the use of physical location. It may be preferable to complete the transaction in a way that uses less physical location. For example, consistently completing the transaction using an account that uses less hardware computing resources, software computing resources, and/or bandwidth may lead to requiring less physical location to meet a long-term need for completing multiple transactions over time.

Minimizing resource consumption may include minimizing energy consumption. Energy may be consumed using hardware computing resources. Energy may be consumed using software computing resources. Energy may be consumed using bandwidth such as network bandwidth. Energy may be consumed using physical location. Minimizing energy consumption may include reducing the amount of energy expended to use hardware computing resources, software computing resources, network bandwidth, and/or physical location.

Minimizing energy consumption may include a reduction in consumption of kilowatt-hours (“kWh”), megajoules (“MJ”), and the like. Minimizing energy consumption may result in energy savings over a month of more than 2 kWh, more than 5 kWh, more than 10 kWh, more than 20 kWh, more than 50 kWh, or more than 100 kWh. Minimizing energy consumption may result in energy savings over a year of more than 100 KJ, more than 250 KJ, more than 500 KJ, more than 1,000 KJ, more than 2,500 KJ, or more than 10,000 KJ.

Minimizing energy consumption may result in energy savings over a month of 2 kWh to 50 kWh, or 5 kWh to 100 kWh. Minimizing energy consumption may result in energy savings over a year of 100 KJ to 2,500 KJ, or 500 KJ to 10,000 KJ.

The GPU may be configured to determine automatically a first series of factors with which to provide the AI model. The first series of factors may include entity-focused factors. The entity-focused factors may include accounts available to the entity for completing the transaction. The account may be a checking account, a savings account, a brokerage account, or the like. The entity-focused factors may include an account balance for each account. The entity-focused factors may include fees associated with an account such as low balance fees. The entity-focused factors may include a time limit for completing the transaction. The entity-focused factors may include access to accounts such as through digital banking and/or banking at a brick-and-mortar location.

The entity-focused factors may include the currency of the account balance for each account. The entity-focused factors may include the currency choices available for completing the transaction. The entity-focused factors may include the resource consumption associated with an account when used to complete the transaction.

Entity-focused factors may include factors that relate to the entity, such as factors that relate directly and/or exclusively to the entity. Entity-focused factors may include, e.g., address, account number, phone number, webpage address, personnel data, financial information, corporate structure, and/or subjective preferences of the entity such as a preferred currency to use to complete a transaction.

The entity may be a corporation. The entity may be an organization. The entity may be a for-profit entity, such as a for-profit corporation. The entity may be a nonprofit entity, such as a nonprofit organization.

The GPU may be configured to determine automatically a second series of factors with which to provide the AI model. The second series of factors may include regional factors. Regional factors may include factors that are related to one or more regions of the parties making the transaction.

One or more of the second series of factors may be used by the AI model. The second series of factors may relate to predicting values of the currency choices available for use in completing the transaction. Predicting values of the currency may include predicting the value of the currency choices in one or more regions of the parties making the transaction.

The regional factors may be determined and/or obtained automatically by the GPU. The regional factors may include purchasing power parity between the currency choices available for completing the transaction. Purchasing power parity may look at the prices of goods in different countries. The purchasing power parity forecasting approach may be based on a theoretical law of one price. The theoretical law of one price may include identical goods in different countries costing identical prices in a free market.

The regional factors may include the relative economic strength of regions issuing the currency choices available for completing the transaction. Determining the relative economic strength of different regions may help determine the direction of the exchange rates between those different regions. Factors that may weigh into a higher relative economic strength include economic growth in that region. Another factor may include high interest rates which may attract economic growth by attracting investment from other regions.

The regional factors may include economic modeling for the regions in which the currency choices are available for completing the transaction. Economic modelling may include gathering factors that may affect changes in currency in a region and building a model from those factors. Factors that may be included in the model may include gross domestic product, stock market growth, interest rates, unemployment rates, and/or income growth.

Regional factors may include a ranking of the geopolitical stability of the region. For example, political stability and absence of violence and/or terrorism. One such quantification may include rankings for regions by the World Bank Group. A ranking of 0-20 may have the lowest rating for political stability and absence of violence and/or terrorism. A ranking of 80-100 may have the highest rating for political stability and absence of violence and/or terrorism. As a region's ranking gets closer to 100, the region is deemed to have greater political stability and absence of violence and/or terrorism. As a region's ranking gets closer to 0, the region is deemed to have greater political stability and absence of violence and/or terrorism.

Regional factors may include factors that relate to a region that hosts the entity. The region may include a location larger than the entity. The region may include land administered by a governing body such as a city, a metropolitan area, a county, a state, a group of states, a country, or a union of countries. For example, regions of the United States may include the Northeast region, the Southeast region, the Midwest region, the Southwest region, and the West region. The region may include a shared language, government, economy, or the like.

The GPU may be configured to automatically provide the first series of factors to the AI model. The GPU may be configured to automatically provide the second series of factors to the AI model.

The GPU may be configured to run the AI model to automatically direct the action of the entity to complete the transaction. The AI model may automatically direct the action of the entity to minimize resource consumption incurred by the entity to complete the transaction. The AI model may use the first series of factors and the second series of factors.

The entity may be operable to manually override the systems and methods to complete the transaction. The entity may manually override the systems and methods to complete the transaction.

The entity-focused factors may further include automatically determining a low balance fee for each account when the account balance falls below a predetermined low balance threshold. The entity-focused factors may further include a cost of an overdraft fee for each account when the account is overdrawn. The entity-focused factors may further include an interest rate provided for the account balance in each account. Avoiding the incurrence of a low balance fee and/or an overdraft fee may result in minimizing resource consumption. Maximizing the interest rate received for each account may result in minimizing resource consumption.

The systems and methods may further include using the AI model to automatically direct the actions of the entity by gathering entity-focused factors and regional factors used to determine which account to use to complete the transaction in a way that minimizes resource consumption and maximizes fluidity for each account. Maximizing the fluidity of an account may include maintaining the account balance to be greater than a predetermined fluidity threshold. The GPU may run the AI model to maximize the fluidity of each account by maintaining the account balance of each account to be greater than a predetermined fluidity threshold. Maintaining a balance in each account that is above the predetermined fluidity threshold may result in maximizing the fluidity of each account.

Implementations of the techniques described may include hardware, a method or process, and/or computer software on a computer-accessible medium.

The systems and methods described herein are illustrative. Systems and methods in accordance with this disclosure will now be described in connection with the figures, which form a part hereof. The figures show illustrative features of systems and methods in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as systems and/or methods, may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

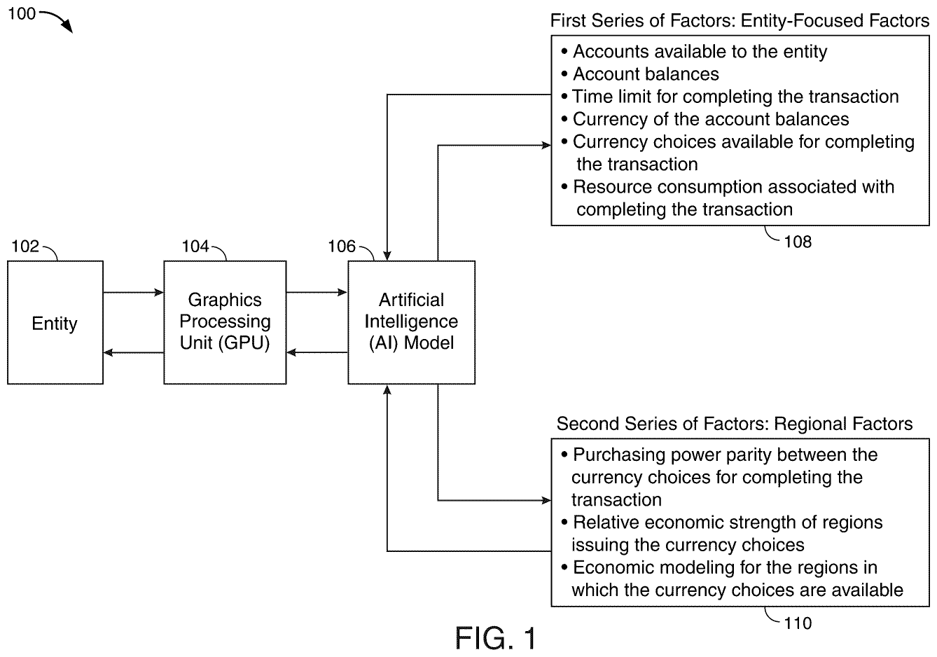

FIG. 1 shows illustrative block diagram 100. Block diagram 100 may be a system. The system may be configured to automate a direction of actions of an entity using entity-focused factors and regional factors. The system may include entity 102. Entity 102 may initiate a request to complete a transaction to graphics processing unit (GPU) 104. GPU 104 may be configured to run artificial intelligence (AI) model 106. GPU 104 may be configured to run AI model 106 to determine first series of factors: entity-focused factors 108.

First series of factors: entity-focused factors 108 may include accounts available to the entity for completing the transaction, account balance for each account, time limit for completing the transaction, currency of the account balance for each account, currency choices available for completing the transaction, and/or resource consumption associated with an account when used to complete the transaction.

GPU 104 may be configured to run AI model 106 to determine second series of factors: regional factors 110. Second series of factors: regional factors 110 may include purchasing power parity between the currency choices available for completing the transaction, relative economic strength of regions issuing the currency choices available for completing the transaction, and/or economic modeling for the regions in which the currency choices are available for completing the transaction.

AI model 106 may receive automatically the first series of factors: entity-focused factors 108. AI model 106 may receive automatically the second series of factors: regional factors 110. GPU 104 may receive feedback from AI model 106. GPU 104 may be configured to automatically direct the action of entity 102 to complete the transaction.

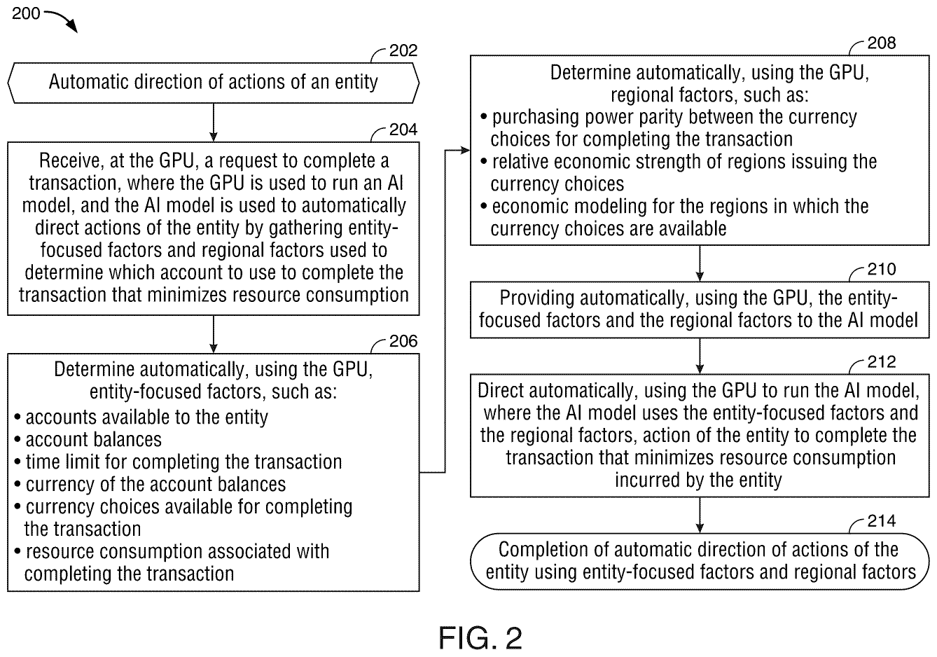

FIG. 2 shows illustrative flowchart 200. Illustrative flowchart 200 may begin at step 202, showing a method for automatically directing actions of an entity using entity-focused factors and regional factors. The method may continue at step 204 by receiving, at the GPU of the entity, a request to complete a transaction. The GPU may be used to run an AI model. The AI model may automatically direct actions of the entity by gathering entity-focused factors and regional factors used to determine which account to use to complete the transaction that minimizes resource consumption.

The method may continue at step 206 by determining automatically, using the GPU, a first series of factors with which to provide the AI model. The first series of factors may include the entity-focused factors, such as accounts available to the entity for completing the transaction, an account balance for each account, a time limit for completing the transaction, a currency of the account balance for each account, currency choices available for completing the transaction, and/or resource consumption associated with an account when used to complete the transaction.

The method may continue at step 208 by determining automatically, using the GPU, one or more of a second series of factors with which to provide the AI model. The second series of factors may include currency choices available to complete the transaction. The second series of factors include regional factors, such as purchasing power parity between the currency choices available for completing the transaction, relative economic strength of regions issuing the currency choices available for completing the transaction, and/or economic modeling for the regions in which the currency choices are available for completing the transaction.

The method may continue at step 210 by providing automatically, using the GPU, the first series of factors and the second series of factors to the AI model. The method may continue at step 212 by using the GPU to run the AI model to direct action of the entity to complete the transaction that minimizes resource consumption incurred by the entity to complete the transaction. The AI model may use the first series of factors and the second series of factors.

The method may continue at step 214 with the completion of automatic direction of actions of the entity using entity-focused factors and regional factors.

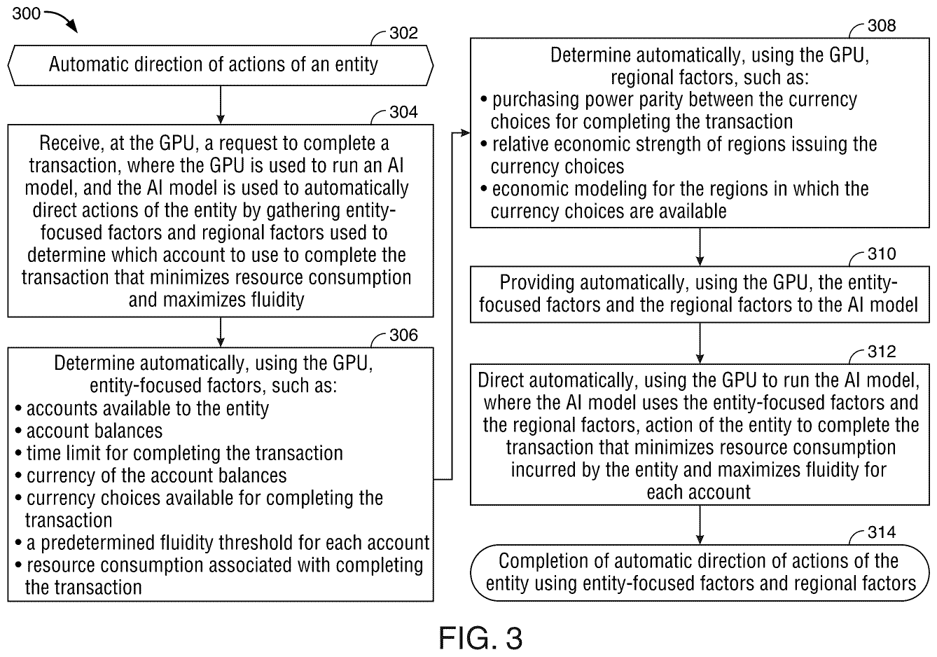

FIG. 3 shows illustrative flowchart 300. Illustrative flowchart 300 may begin at step 302, showing a method for automatically directing actions of an entity using entity-focused and regional factors. The method may continue at step 304 by receiving, at the GPU of the entity, a request to complete a transaction. The GPU may be used to run an AI model. The AI model may automatically direct actions of the entity by gathering entity-focused factors and regional factors used to determine which account to complete the transaction that minimizes resource consumption and maximizes fluidity.

The method may continue at step 306 by determining automatically, using the GPU, a first series of factors with which to provide the AI model. The first series of factors may include the entity-focused factors, such as accounts available to the entity for completing the transaction, an account balance for each account, a time limit for completing the transaction, a currency of the account balance for each account, currency choices available for completing the transaction, a predetermined fluidity threshold for each account, and/or resource consumption associated with an account when used to complete the transaction.

The method may continue at step 308 by determining automatically, using the GPU, one or more of a second series of factors with which to provide the AI model. The second series of factors may include currency choices available to complete the transaction. The second series of factors include regional factors, such as purchasing power parity between the currency choices available for completing the transaction, relative economic strength of regions issuing the currency choices available for completing the transaction, and/or economic modeling for the regions in which the currency choices are available for completing the transaction.

The method may continue at step 310 by providing automatically, using the GPU, the first series of factors and the second series of factors to the AI model. The method may continue at step 312 by using the GPU to run the AI model to direct action of the entity to complete the transaction that minimizes resource consumption incurred by the entity to complete the transaction and maximizes fluidity for each account, where fluidity is maximized when the account balance of each account is maintained to be greater than the predetermine fluidity threshold for each account. The AI model may use the first series of factors and the second series of factors.

Direct automatically, using the GPU to run the AI model, where the AI model uses the first series of factors and the second series of factors, action of the entity to complete the transaction that minimizes resource consumption incurred by the entity to complete the transaction and maximizes fluidity for each account, where fluidity of each account is maximized when the account balance of each account is maintained to be greater than the predetermine fluidity threshold for each account

The method may continue at step 314 with the completion of automatic direction of actions of the entity using entity-focused factors and regional factors.

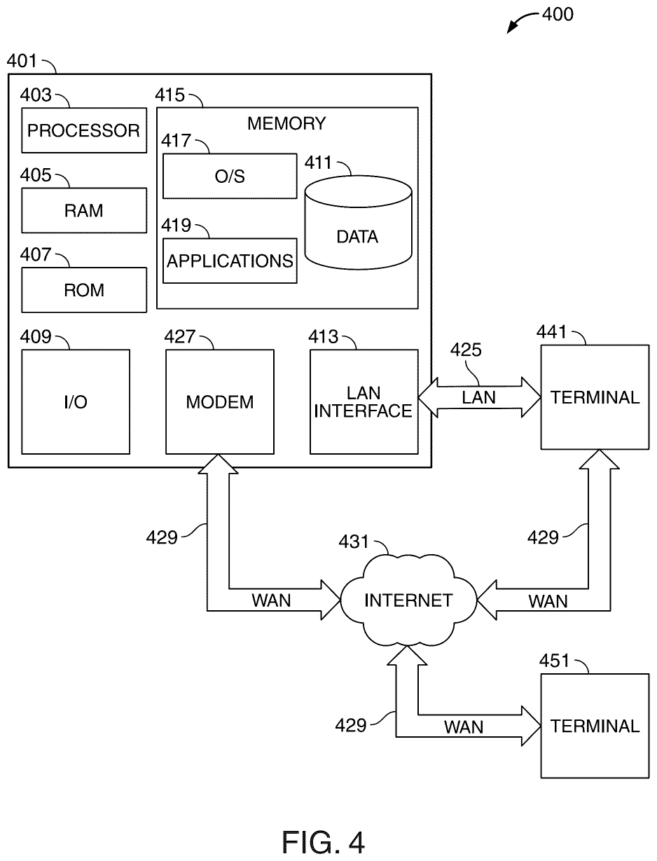

FIG. 4 shows an illustrative block diagram of system 400 that includes computer 401. Computer 401 may alternatively be referred to herein as an “engine,” “server” or a “computing device.” Computer 401 may be a workstation, desktop, laptop, tablet, smartphone, or any other suitable computing device. Elements of system 400, including computer 401, may be used to implement various aspects of the systems and methods disclosed herein. Each of the systems, methods, and algorithms illustrated below may include some or all the elements of system 400.

Computer 401 may have a processor 403, including a central processing unit (“CPU”), for controlling the operation of the device and its associated components, and may include RAM 405, ROM 407, input/output (“I/O”) 409, and a non-transitory or non-volatile memory 415. Machine-readable memory may be configured to store information in machine-readable data structures. Processor 403 may also execute all software running on the computer. Other components, such as graphics processing unit (“GPU”), EEPROM, Flash memory, neural-network processing elements, or any other suitable components, may also be part of the computer 401.

Memory 415 may be comprised of any suitable permanent storage technology—e.g., a hard drive. Memory 415 may store software including the operating system 417 and application program(s) 419 along with any data 411 needed for the operation of the system 400. Memory 415 may also store videos, text, and/or audio assistance files. The data stored in memory 415 may also be stored in cache memory, or any other suitable memory.

I/O module 409 may include connectivity to a microphone, keyboard, touch screen, mouse, and/or stylus through which input may be provided into computer 401. The input may include input relating to cursor movement. The input/output module may also include one or more speakers for providing audio output and a video display device for providing textual, audio, audiovisual, and/or graphical output. The input and output may be related to computer application functionality.

System 400 may be connected to other systems via a local area network interface 413. System 400 may operate in a networked environment supporting connections to one or more remote computers, such as terminals 441 and 451. Terminals 441 and 451 may be personal computers or servers that include many, or all the elements described above relative to system 400. The network connections depicted in FIG. 4 include a local area network (“LAN”) 425 and a wide area network (“WAN”) 429 but may also include other networks. When used in a LAN networking environment, computer 401 is connected to LAN 425 through LAN interface 413 or an adapter. When used in a WAN networking environment, computer 401 may include a modem 427 or other means for establishing communications over WAN 429, such as Internet 431.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or an API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 419, which may be used by computer 401, may include computer executable instructions for invoking functionality related to communication, such as e-mail, Short Message Service (“SMS”), and voice input and speech recognition applications. Application program(s) 419 (which may be alternatively referred to herein as “plugins,” “applications,” or “apps”) may include computer executable instructions for invoking functionality related to performing various tasks. Application program(s) 419 may utilize one or more algorithms that process receive executable instructions, perform power management routines or other suitable tasks.

Application program(s) 419 may include computer executable instructions (alternatively referred to as “programs”). The computer executable instructions may be embodied in hardware or firmware (not shown). Computer 401 may execute the instructions embodied by the application program(s) 419 to perform various functions.

Application program(s) 419 may utilize the computer-executable instructions executed by a processor. Programs may include routines, programs, objects, components, data structures, etc., that perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 411, and any other suitable information, may be stored in memory 415.

The disclosure may be described in the context of computer-executable instructions, such as application(s) 419, being executed by a computer. Programs may include routines, programs, objects, components, data structures, etc., that perform tasks or implement data types. The disclosure may also be practiced in distributed computing environments. Tasks may be performed by remote processing devices that are linked through a communications network. In a distributed computing environment, programs may be in both local and remote computer storage media including memory storage devices. It should be noted that such programs may be considered for the purposes of this application as engines with respect to the performance of the tasks to which the programs are assigned.

Computer 401 and/or terminals 441 and 451 may also include various other components, such as a battery, speaker, and/or antennas (not shown). Components of computer system 401 may be linked by a system bus, wirelessly or by other suitable interconnections. Components of computer system 401 may be present on one or more circuit boards. In some embodiments, the components may be integrated into a single chip. The chip may be silicon-based.

Terminal 441 and/or terminal 451 may be portable devices such as a laptop, cell phone, tablet, smartphone, or any other computing system for receiving, storing, transmitting, and/or displaying relevant information. Terminal 441 and/or terminal 451 may be one or more user devices. Terminals 441 and 451 may be identical to system 400 or different. Differences may be related to hardware components and/or software components.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

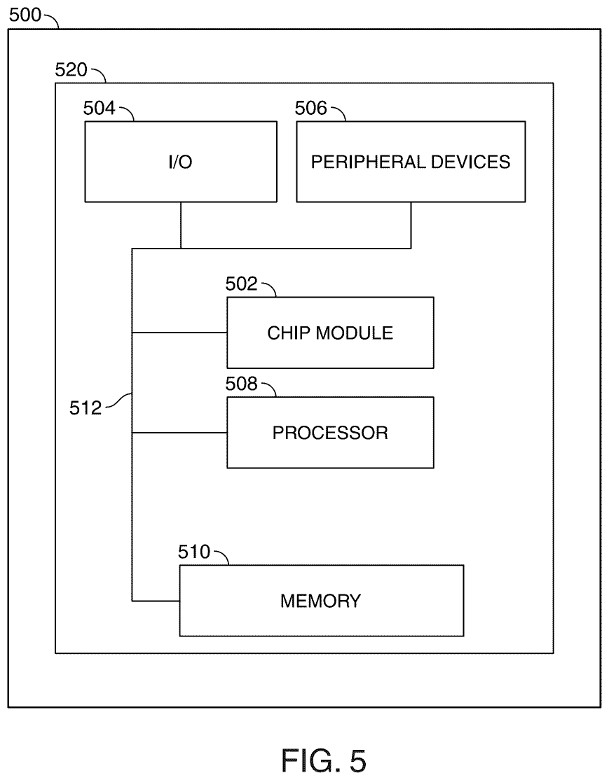

FIG. 5 shows an illustrative system 500 that may be configured in accordance with the principles of the disclosure. System 500 may be a computing device. System 500 may include one or more features of the apparatus shown in FIG. 5. System 500 may include chip module 502, that may include one or more integrated circuits, and that may include logic configured to perform any other suitable logical operations.

System 500 may include one or more of the following components: I/O circuitry 504, that may include a transmitter device and a receiver device and may interface with fiber optic cable, coaxial cable, telephone lines, wireless devices, PHY layer hardware, a keypad/display control device or any other suitable media or devices; peripheral devices 506, that may include counter timers, real-time timers, power-on reset generators or any other suitable peripheral devices; logical processing device 508, that may compute data structural information and structural parameters of the data; and machine-readable memory 510.

Machine-readable memory 510 may be configured to store in machine-readable data structures: machine executable instructions, (which may be alternatively referred to herein as “computer instructions” or “computer code”), applications such as applications 419 (shown in FIG. 4), signals, and/or any other suitable information or data structures.

A system bus or other interconnections 512 may couple components 502, 504, 506, 508 and 510 and may be present on one or more circuit boards such as circuit board 520. In some embodiments, a single chip may integrate the components. The chip may be silicon-based.

Thus, provided may be systems and methods relating to automatically directing actions of an entity using entity-focused factors and regional factors. People skilled in the art will appreciate that the present invention can be practiced by other than the described embodiments, which are presented for purposes of illustration rather than of limitation. The present invention is limited only by the claims that follow.

1. A method for automatically directing actions of an entity to complete transactions using entity-focused factors and regional factors, the method comprising:
receiving, at a graphics processing unit (“GPU”) of the entity, a request to complete a transaction, said GPU used to run an artificial intelligence (“AI”) model where the GPU runs the AI model by using parallel processing to break down computations into smaller chunks and distribute them across thousands of cores for performing matrix multiplication operations, said AI model used to automatically direct actions of the entity by gathering entity-focused factors and regional factors used to determine one or more accounts available to the entity for completing the transaction;
determining automatically, using the GPU, a first series of factors with which to provide the AI model, said first series of factors comprising the entity-focused factors, said entity-focused factors comprising:
the one or more accounts available to the entity for completing the transaction;
an account balance for each account;
a time limit for completing the transaction;
a currency of the account balance for each account;
currency choices available for completing the transaction; and
resource consumption associated with an account when used to complete the transaction;
determining automatically, using the GPU, a second series of factors with which to provide the AI model, said second series of factors comprising regional factors, said second series of factors relating to currency choices available to complete the transaction, said regional factors comprising:
purchasing power parity between the currency choices available for completing the transaction, said purchasing power parity based on a theoretical law of one price wherein identical goods in different countries cost identical prices in a free market;
relative economic strength of regions issuing the currency choices available for completing the transaction, said relative economic strength determined by factors including economic growth and interest rates in each region; and
economic modeling for the regions issuing the currency choices available for completing the transaction, said economic modeling including gross domestic product, stock market growth, interest rates, unemployment rates, and income growth for each region;
providing automatically, using the GPU, the first series of factors and the second series of factors to the AI model; and
directing automatically, using the GPU to run the AI model wherein the AI model uses the first series of factors and one or more of the second series of factors, actions of the entity to complete the transaction.

2. The method of claim 1 wherein the entity-focused factors further comprise:
a predetermined low balance threshold for each account; and
a low balance fee for each account;
wherein, for a given account, a low balance fee for the given account is charged when the account balance falls below a predetermined low balance threshold for the given account.

3. The method of claim 1 wherein the entity-focused factors further comprise an overdraft fee for each account that is overdrawn.

4. The method of claim 1 wherein the entity-focused factors further comprise an interest rate provided for the account balance for each account.

5. The method of claim 1 wherein two or more of the second series of factors are used by the AI model.

6. The method of claim 1 wherein the entity is operable to manually override the method to complete the transaction.

7. A system for automated direction of actions of an entity to complete transactions using entity-focused factors and regional factors, the system comprising:
a graphics processing unit (“GPU”) of the entity;
an artificial intelligence (“AI”) model;
said GPU configured to:
receive a request to complete a transaction, GPU is configured to run the AI model by using parallel processing to break down computations into smaller chunks and distribute them across thousands of cores for performing matrix multiplication operations, said AI model used to automatically direct actions of the entity by gathering entity-focused factors and regional factors used to determine one or more accounts available to the entity for completing the transaction;
determine automatically a first series of factors with which to provide the AI model, said first series of factors comprising the entity-focused factors, said entity-focused factors comprising:
the one or more accounts available to the entity for completing the transaction;
an account balance for each account;
a time limit for completing the transaction;
a currency of the account balance for each account;
currency choices available for completing the transaction; and
resource consumption associated with an account when used to complete the transaction;
determine automatically a second series of factors with which to provide the AI model, said second series of factors comprising regional factors, said second series of factors relating to currency choices available to complete the transaction, said regional factors comprising:
purchasing power parity between the currency choices available for completing the transaction, said purchasing power parity based on a theoretical law of one price wherein identical goods in different countries cost identical prices in a free market;
relative economic strength of regions issuing the currency choices available for completing the transaction, said relative economic strength determined by factors including economic growth and interest rates in each region; and
economic modeling for the regions issuing the currency choices available for completing the transaction, said economic modeling including gross domestic product, stock market growth, interest rates, unemployment rates, and income growth for each region;
provide automatically the first series of factors and the second series of factors to the AI model; and
run the AI model to automatically direct the actions of the entity to complete the transaction, wherein the AI model uses the first series of factors and one or more of the second series of factors.

8. The system of claim 7 wherein the entity-focused factors further comprise:
a predetermined low balance threshold for each account; and
a low balance fee for each account;
wherein, for a given account, a low balance fee for the given account is charged when the account balance falls below a predetermined low balance threshold for the given account.

9. The system of claim 7 wherein the entity-focused factors further comprise an overdraft fee for each account that is overdrawn.

10. The system of claim 7 wherein the entity-focused factors further comprise an interest rate provided for the account balance for each account.

11. The system of claim 7 wherein two or more of the second series of factors are used by the AI model.

12. The system of claim 7 wherein the entity is operable to manually override the system to complete the transaction.

13. A method for automatically directing actions of an entity to complete transactions using entity-focused factors and regional factors, the method comprising:
receiving, at a graphics processing unit (“GPU”) of the entity, a request to complete a transaction, said GPU used to run an artificial intelligence (“AI”) model where the GPU runs the AI model by using parallel processing to break down computations into smaller chunks and distribute them across thousands of cores for performing matrix multiplication operations, said AI model used to automatically direct actions of the entity by gathering entity-focused factors and regional factors used to determine one or more accounts available to the entity for completing the transaction in a way that minimizes resource consumption and maximizes fluidity;
determining automatically, using the GPU, a first series of factors with which to provide the AI model, said first series of factors comprising entity-focused factors, said entity-focused factors comprising:
the one or more accounts available to the entity for completing the transaction in a way that minimizes resource consumption and maximizes fluidity;
an account balance for each account;
a time limit for completing the transaction;
a currency of the account balance for each account;
currency choices available for completing the transaction;
a predetermined fluidity threshold for each account; and
resource consumption associated with an account when used to complete the transaction;
determining automatically, using the GPU, a second series of factors with which to provide the AI model, said second series of factors comprising regional factors, said second series of factors relating to currency choices available to complete the transaction, said regional factors comprising:
purchasing power parity between the currency choices available for completing the transaction, said purchasing power parity based on a theoretical law of one price wherein identical goods in different countries cost identical prices in a free market;
relative economic strength of regions issuing the currency choices available for completing the transaction, said relative economic strength determined by factors including economic growth and interest rates in each region; and
economic modeling for the regions issuing the currency choices available for completing the transaction, said economic modeling including gross domestic product, stock market growth, interest rates, unemployment rates, and income growth for each region;
providing automatically, using the GPU, the first series of factors and the second series of factors to the AI model; and
directing automatically, using the GPU to run the AI model wherein the AI model uses the first series of factors and one or more of the second series of factors, actions of the entity to complete the transaction, minimize resource consumption incurred by the entity to complete the transaction, and maximize fluidity for each account;
wherein fluidity of each account is maximized when the account balance of each account is maintained to be greater than the predetermined fluidity threshold for each account, said predetermined fluidity threshold defined as maintaining the account balance to avoid fees and preserve account accessibility, wherein the predetermined fluidity threshold for each account is equal to or greater than a predetermined low balance threshold for each account; and
wherein minimization of resource consumption incurred by the entity to complete the transaction comprises minimizing use of bandwidth, said minimizing the use of bandwidth comprises less information that needs to be conveyed over a communication network, where the GPU runs the AI model to determine a path for completing the transaction that requires a least amount of information among various options for paths to complete the transaction.

14. The method of claim 13 wherein the entity-focused factors further comprise:
a predetermined low balance threshold for each account; and
a low balance fee for each account;
wherein, for a given account, a low balance fee for the given account is charged when the account balance falls below a predetermined low balance threshold for the given account.

15. The method of claim 14 wherein, for a given account, the predetermined fluidity threshold is equal to or greater than the predetermined low balance threshold.

16. The method of claim 13 wherein the entity-focused factors further comprise an overdraft fee for each account that is overdrawn.

17. The method of claim 13 wherein the entity-focused factors further comprise an interest rate provided for the account balance for each account.

18. The method of claim 13 wherein two or more of the second series of factors are used by the AI model.

19. The method of claim 13 wherein the AI model uses all the second series of factors.

20. The method of claim 13 wherein the entity is operable to manually override the method to complete the transaction.
